(19) United States
(12) Patent Application Publication
(10) Pub. No.: US 2010/0285877 A1
(43) Pub. Date: Nov. 11, 2010

(54) DISTRIBUTED MARKERLESS MOTION CAPTURE

(75) Inventor: Stefano Corazza, San Francisco, CA (US)

Correspondence Address: KAUTH , POMEROY , PECK & BAILEY ,LLP, 2875 MICHELLE DRIVE, SUITE 110, IRVINE, CA, 92606, US

(73) Assignee: Mixamo, Inc., San Francisco, CA (US)

(21) Appl. No.: 12/774,689

(22) Filed: May 5, 2010

Related U.S. Application Data
(60) Provisional application No. 61/215,374, filed on May 5, 2009.

(51) Int. Cl. A63F 13/00; G06T 15/70; A63F 9/24

(52) U.S. Cl. 463/32; 345/419; 463/43

(57) ABSTRACT

Systems and methods for performing remote markerless motion capture to drive 3D animations in real time in accordance with embodiments of the invention are described. One embodiment of the invention includes an optical device connected to a data acquisition device, where the combination of the optical device and the data acquisition device is configured to perform markerless motion capture, and a server system configured to communicate with the data acquisition device via the Internet. In addition, the server system is configured to receive motion capture data from the data acquisition device, and the server system is configured to generate motion data to animate a 3D character model based upon the received motion capture data.

### RELATED APPLICATION

This application claims priority to U.S. Provisional. Application No. 61/215,374, filed May 5, 2009, the disclosure of which is incorporated herein by reference

### BACKGROUND

The present invention generally relates to 3D character animation and more specifically relates to the animation of 3D characters in multi-user virtual/interactive environments, video games, virtual worlds, animation movies, virtual reality, simulation, ergonomics, industrial design and architecture.

The entertainment market is rapidly growing and general trends see the industry moving towards more interaction between the produced content (i.e. video games, movies, virtual worlds, etc.) and the user, and more interaction between users/players. The success of new control devices such as the Wii manufactured by Nintendo Co., Ltd. of Kyoto, Japan and the growth of massive multiplayer online games both illustrate these trends. Amongst the entertainment industry, the video game segment has seen significant growth in terms of use and diffusion in the last decade. Despite the growth, the advancement beyond haptic gaming interfaces has been limited. The EyeToy manufactured by Sony Corporation of Tokyo, Japan and the Wii are examples of very few successful attempts to make user/gaming console interaction easier and more natural.

### SUMMARY

Systems and methods for performing remote markerless motion capture to drive 3D animations in accordance with embodiments of the invention are described. One embodiment of the invention includes an optical device connected to a data acquisition device, where the combination of the optical device and the data acquisition device is configured to perform markerless motion capture, and a server system configured to communicate with the data acquisition device via the Internet. In addition, the server system is configured to receive motion capture data from the data acquisition device, and the server system is configured to generate motion data to animate a 3D character model based upon the received motion capture data.

In a further embodiment, the optical device is a time of flight camera.

In another embodiment, the data acquisition device includes a game engine client configured to render 3D animations based upon 3D animation information received from the server system, and the server system is configured to stream 3D animation information to the data acquisition device including the motion data generated by the server system based upon the received motion capture data.

In a still further embodiment, the server system is configured to control the frame rate of the generated animation data in response to the frame rate of the received motion capture data and in response to Internet bandwidth constraints.

In still another embodiment, the server system is configured to match the motion capture data against a set of predetermined command gestures, and the server system is configured to generate predetermined motion data based upon matching the motion capture data with a command.

In a yet further embodiment, the server system is configured to generate motion data influenced by the received motion capture data.

In yet another embodiment, the server system is configured to generate motion data by at least retargeting the motion data to a 3D character model.

In a further embodiment again, the server system is configured to generate motion data by at least generating synthetic motion data influenced by the retargeted motion capture data.

In another embodiment again, the server system is configured to generate motion data by at least generating synthetic motion data influenced by the received motion capture data, and combining aspects of the received motion data with aspects of the synthetic motion data.

An embodiment of the method of the invention includes performing markerless motion capture using an optical device, providing the markerless motion capture data to a remote server system, generating motion data using the server system based upon the markerless motion capture data, and animating a 3D character using the generated motion data.

In a further embodiment of the method of the invention, the optical device is a time of flight camera.

In another embodiment of the method of the invention, the markeless motion capture data is expressed in terms of joint center points and joint rotation parameters.

A still further embodiment of the method of the invention also includes matching the markerless motion data using the server system against a predetermined set of commands, and generating the motion data using a predetermined motion associated with an identified command.

Still another embodiment of the method of the invention also includes generating motion data influenced by the received motion capture data using the server system.

A yet further embodiment of the method of the invention also includes retargeting the received motion data to a 3D character model using the server system.

Yet another embodiment of the method of the invention also includes generating synthetic motion data influenced by the retargeted received motion data.

A further embodiment again of the method of the invention also includes generating motion data based upon a combination of aspects of the synthetic motion data and aspects of the received motion data.

Another embodiment again of the method of the invention also includes streaming 3D animation information including the generated motion capture data to a rendering engine client located remotely.

Another further embodiment of the method of the invention also includes modifying the frame rate of the animation information streamed by the server system in response to the frame rate of the motion capture data received by the server system and the internet bandwidth constraints.

### BRIEF DESCRIPTION OF THE DRAWINGS

FIG. 1 is a block diagram illustrating a system for performing remote markerless motion capture to drive 3D animation in real time in accordance with an embodiment of the invention.

FIG. 2 conceptually illustrates a multi-player video game or interactive movie system configured to control. 3D characters in response to gestures captured remotely using markerless motion capture in accordance with an embodiment of the invention.

FIG. 3 is a flow chart illustrating a process for generating motion data to animate a 3D character based upon remotely captured motion data in accordance with an embodiment of the invention.

FIG. 4 conceptually illustrates a multi-player video game or interactive movie system configured to animate 3D characters based upon remotely captured motion data in accordance with an embodiment of the invention.

### DETAILED DESCRIPTION

Turning now to the drawings, systems and methods for performing remote markerless motion capture to drive 3D animations in real time in accordance with embodiments of the invention are described. Systems in accordance with embodiments of the invention include an optical device connected to a data acquisition device, which together perform markerless motion capture. The markerless motion capture data is then forwarded to a server system via the Internet. The server system processes the motion capture data and extracts information that can be used to generate motion data for animating a 3D character model. In several embodiments, the server system streams the motion data to the data acquisition device, which is configured to render a 3D animation using the streamed motion data. In a number of embodiments, systems for performing remote markerless motion capture are used to animate 3D characters in video games. In many embodiments, multiple systems are used to animate 3D characters in multi-player video games.

### System Architecture

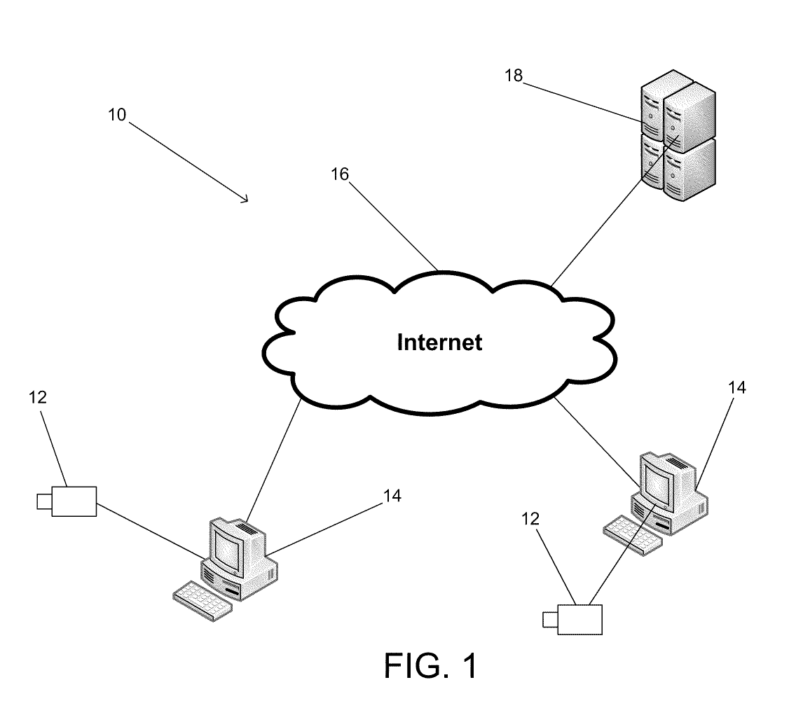

A system for performing remote markerless motion capture to drive 3D animations in real time in accordance with an embodiment of the invention is illustrated in FIG. 1. The system 10 includes at least one distributed motion capture systems that includes an optical device 12 connected to a data acquisition device. As is discussed further below, the optical device can be one or more cameras including but not limited to time of flight cameras and the combination of the optical device and data acquisition device is configured to perform markerless motion capture. The motion capture data acquired by the data acquisition device is streamed via the Internet 16 to a remotely located server system 18. The server system is configured to process the streamed markerless motion capture data and to generate motion data capable of animating a 3D character. In many embodiments, the motion data is streamed to the data acquisition device and is used by the data acquisition device to render a 3D animation on a display device. In several embodiments, markerless motion capture is performed in multiple locations and the streams of markerless motion capture information are used by the server system to animate 3D characters in a multi-player environment such as, but not limited to, a multi-player video game or interactive movie. Although a specific architecture is illustrated in FIG. 1, other architectures can be utilized that satisfy the requirements of specific applications, including applications that are not related to multi-player video games, in accordance with embodiments of the invention. Various systems for performing remote markerless motion capture to drive 3D animations in real time in accordance with embodiments of the invention are discussed further below.

### Markerless Motion Capture

Markerless motion capture is a term used to describe the capture of the motion of a subject in 3D space without the assistance of markers to provide indications of articulated joints. Techniques for performing markerless motion capture are described in U.S. patent application Ser. No. 11/716,130 to Mundermann et al., entitled “Markerless Motion Capture System” the disclosure of which is incorporated by reference herein in its entirety. Techniques for performing markerless motion capture are also described in Corazza et al. “A markerless motion capture system to study musculoskeletal biomechanics: visual hull and simulated annealing approach” Annals of Biomedical. Engineering, 2006, 34(6):1019-29, Muendermann et al. “Accurately measuring human movement using articulated ICP with soft-joint constraints and a repository of articulated models” CVPR 2007, and Corazza et al. “Automatic Generation of a Subject Specific Model for Accurate Markerless Motion Capture and Biomechanical Applications”, IEEE Transactions of Biomedical. Eng., 2009, the disclosure of which is incorporated by reference in its entirety. As is discussed further below, any of a variety of techniques, including but not limited, to techniques that use a single 3D camera, or techniques that use multiple cameras can be utilized to perform markerless motion capture in accordance with embodiments of the invention.

### Optical Devices

A key component of a system used to perform remote markerless motion capture is an optical device 12, which is a sensor or sensors used to capture motion of the performer. In many embodiments, the optical device is a single 3D camera such as a time of flight camera that is capable of reconstructing parts or the entire 3D mesh describing the body surface of the performer. A time of flight camera is a camera system that creates depth map data. A variety of different technologies for time of flight cameras have been developed, however, a time of flight camera typically uses short light pukes to illuminate the scene and then gathers the reflected light and images it onto the sensor plane. Depending on the distance, the incoming light experiences a delay. The delay at each pixel can be used to measure the distance between the surface of the object and the camera.

The use of time of flight cameras to perform motion capture is described in Bleiweiss et al. “Markerless Motion Capture Using a Single Depth Sensor” ACM SIGGRAPH ASIA 2009. Time of flight cameras provide the advantage of enabling markerless motion capture using a single camera. In other embodiments, however, multiple cameras can be used to perform markerless motion capture including but not limited to multiple time of flight cameras and/or multiple conventional cameras. In most instances, any non-invasive (markerless) and easily accessible device is appropriate.

### Data Acquisition Device

The optical device 12 provides information to a data acquisition device 14. In many embodiments, the data acquisition device simply forwards the acquired data to a remote server system. In several embodiments, the data acquisition device is also capable of rendering 3D animation using motion data received from the remote server system. The data acquisition device can be a personal computer, or gaming console that acquires in real time the motion of a performer/player and uses the information as a controller in a game or interactive movie. The data acquisition device can also display in real time the content of the game or interactive movie creating an interactive experience for the performer/player. As noted above, the content can include interaction with other remote players (e.g. multi-player games and massive multi-player games) using a similar system.

In many embodiments, the data acquisition device performs 3D reconstruction and mapping of the captured motion and either forwards the 3D motion to the server system or maps the time-varying motion parameters to the control logic of the game or interactive movie and forwards control commands to the server system. In a number of embodiments that utilize time of flight cameras, the 3D reconstruction and mapping is performed in a manner similar to that described by Bleiweiss et al and incorporated by reference above. In other embodiments, any of a variety of 3D reconstruction and mapping techniques can be used to parameterize the motion capture as a set of variables related to body joint movements.

Many embodiments of the invention involve data acquisition devices that simply forward the motion capture data to the server system. In a number of embodiments, the data acquisition device forwards raw motion data, characterized by joint center points specified in terms of x, y, z coordinates and/or joint rotation parameters. In several embodiments, the raw motion data is converted into a web-friendly format and streamed to the server. A web-friendly format can include but is not limited to, a format that utilizes data compression and/or data encryption. In addition, a web friendly format can be compatible with streaming protocols where the data is organized into a frame-by-frame structure and streamed as such as opposed to a sell-contained motion file which is normally used for offline applications.

### Server System

The raw motion data captured during markerless motion capture is typically unsuited to the animation of a 3D character. Simply retargeting markerless motion data, especially when acquired from a time of flight camera, can result in animations that are rough and jerky. In many embodiments, the server system 18 is where the motion capture data coming from individual data acquisition devices is processed to generate motion data that can be used to realistically animate a 3D character model.

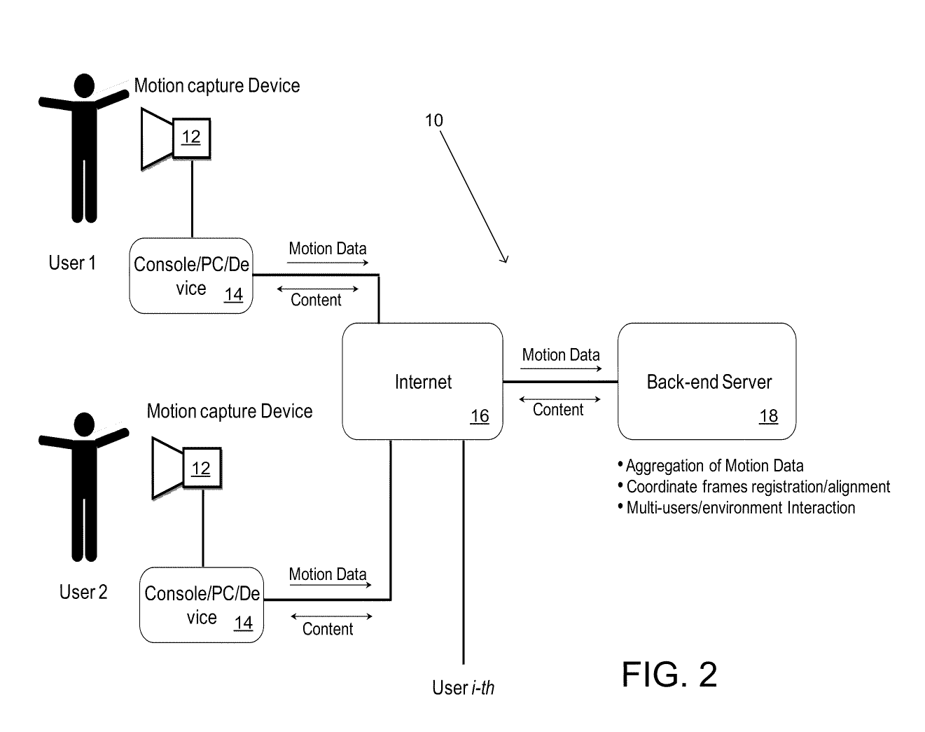

In several embodiments, the server system simply interprets the motion data in a manner similar to the interpretation of instructions from a game controller. Stated another way, the server system simply matches the motion data against a predetermined set of command gestures. Once a command is identified, a 3D character animation can be animated in response to the command in a predefined manner. In this way, the motion data can be used to animate or control a 3D character only in the coarsest sense. Variations in a particular type of motion do not result in variations in the manner in which the 3D character is animated. A system that processes motion data as commands to provide multi-user interaction in the context of a multi-player game or interactive movie in accordance with an embodiment of the invention is illustrated in FIG. 2. In the illustrated embodiment, the server system 18 aggregates the commands indicated by the motion data received from various data acquisition devices 14 and provides content to the data acquisition devices to enable the rendering of pre-determined 3D animations by game engine clients incorporated into the data acquisition devices.

In more advanced systems, server systems in accordance with embodiments of the invention can generate motion data to animate 3D characters that resembles motion data received from data acquisition devices. In such a system, variations in a particular type of motion can result in variations in the manner in which the 3D character is animated. Server systems that generate motion data to animate 3D characters that resembles motion data received from data acquisition devices in accordance with embodiments of the invention are discussed further below.

### Processing of Raw Motion Data

The processing of raw motion data to generate motion data that can realistically animate a 3D character model can be performed in a variety of ways depending upon the quality of the raw motion data. In a number of embodiments, the raw motion data is matched against a library of known motions and the server system generates synthetic motion data to animate a 3D character so that the character performs the identified motion in a manner similar to that captured in the motion capture data. The term synthetic motion data describes motion data that is generated by a machine. Synthetic motion data is distinct from manually generated motion data, where a human animator defines the motion curve of each Avar, and actual motion data obtained via motion capture. The synthetic motion data or a combination of the synthetic motion data and the raw motion capture data can provide a smoother and/or more realistic animation of the 3D character than simply retargeting the raw motion capture data to the 3D character, while preserving the general characteristics of the captured motion. In other embodiments, raw motion capture data of sufficiently high quality can be conditioned and retargeted to the 3D character.

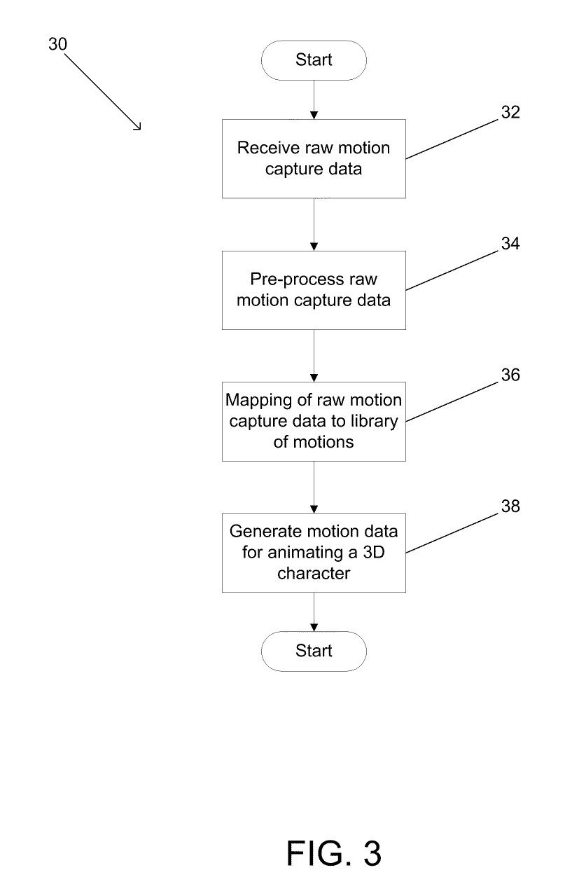

A process for animating a 3D character using synthetic motion data based upon raw motion capture data received from a data acquisition device in accordance with an embodiment of the invention is illustrated in FIG. 3. The process 30 commences with the receipt (32) of the raw motion capture data from a data acquisition device. Although the term “raw” is used refer to the motion capture data, typically some processing has been performed on the images captured by the optical device so that information received by the server system is an efficient representation of the motion observed by the data acquisition device. The received motion capture data is pre-processed (34) to enforce anatomical and physical constraints. If the anatomical and physical constraints are not satisfied, then the raw motion data can be corrected using techniques including but not limited to joint limits, automatic Inverse Kinematics editing (e.g. to avoid ground floor penetration), and collision detection (e.g. legs crossing). The motion data is then typically converted into a hierarchical motion of a 3D character model using a technique such as, but not limited to, a quaternion formulation.

Following the pre-processing, a high level mapping (36) of the received motion data to a high-level descriptor of the motion is performed. Meta-data information is extracted from the motion, such as, but not limited to, pace of the motion, location of the end effectors (e.g. the hands), style, etc. The meta-data can include the results of a classifier that identifies similar motion in a pre-existing library of animations, allowing the matching of the received motion data to a pre-populated repository of motions. The high-level controls basically extract control data from the raw motion and combine it to a matching motion selected from the pre-existing animation library.

In several embodiments, a low level descriptor of the animation is also generated by mapping the input motion data structure to a 3D character model that the server system is configured to animate. High-level and low-level information are then processed in a statistical model used to generate synthetic motion data. The synthetic motion data can represent the baseline of the animation that is to be applied to the 3D character. In one embodiment of the invention the low level interaction and the high level interaction are combined to provide the final motion data that is used to animate the 3D character model. The two interactions can be combined in a variety of ways. For example, the low level interaction can be used to locate end effectors, such as hands, in 3D space correctly, while the high level interaction can provide controls such as the pace of the motion and the characteristics of the motion. Ideally, the resulting motion data is smooth and resembles the motion of the performer. In another embodiment of the invention, only high-level or only low-level data is used to generate the final motion data.

The process completes with the generation (38) of the finalized motion data, which in many embodiments is in the form of a quaternion based representation of the motion that is ready for streaming to the data acquisition device so that its game engine client can render and display the animation. The motion data can also be streamed to other data acquisition devices and/or to a dedicated display device. In many instances, compressions such as keyframe reduction and frame rate dynamic compression can be performed to optimize the performance of the data down-streaming from the server to the rendering device.

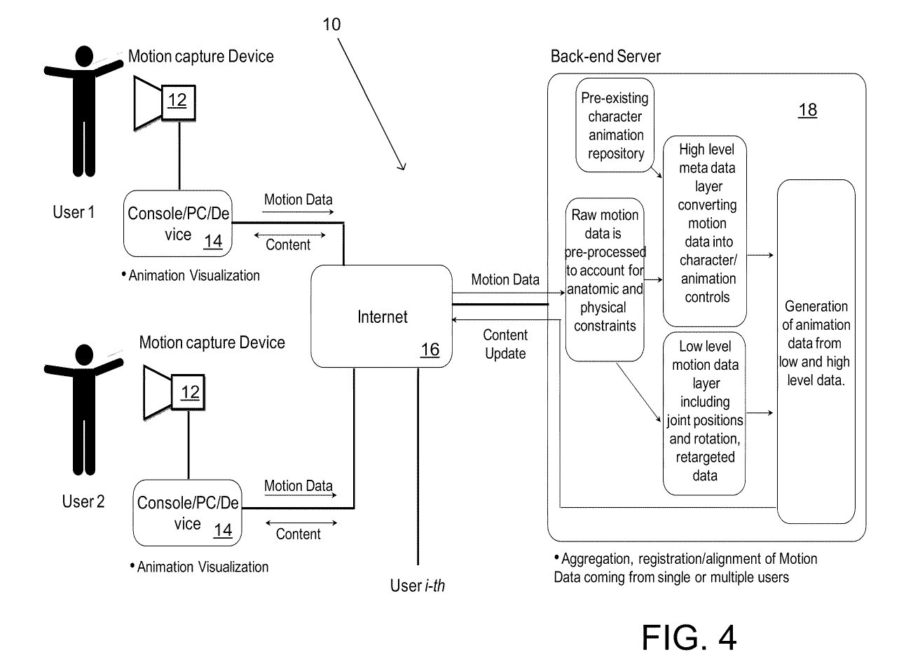

The operation of a system in accordance with an embodiment of the invention utilizing the process illustrated in FIG. 3 in the context of a multi-player game or interactive movie is conceptually illustrated in FIG. 4. Unlike in the system illustrated in FIG. 2, the server system 18 generates motion data influenced by or resembling the motion capture data received from the data acquisition devices 14 and provides the generated motion data to the rendering engines of the relevant data acquisition devices to create a more interactive experience. In many embodiments, the rendered 3D character animations are displayed to the performer through a 3D/virtual reality device that can be worn on the performer's body (e.g. virtual reality goggles) or a standalone device (e.g. a 3D television or holographic display).

Although a specific process is described above with respect to FIGS. 3 and 4 for generating motion data based upon received motion capture data, other processes can be utilized to map the raw motion capture data to a 3D character model including but not limited to processes that do not involve the generation of synthetic motion data, but simply condition and retarget the raw motion capture data to the 3D character model in accordance with embodiments of the invention.

### Upstream/Downstream Streaming Protocol

Systems in accordance with embodiments of the invention can involve a data acquisition device receiving motion data for the rendering of 3D character animations in real time in response to motion captured by the data acquisition device. Accordingly, protocols between the server system and the data acquisition devices can be implemented that allow for bi-directional motion streaming: from the data acquisition device to the server system in terms of raw motion capture data; and from the server system to the data acquisition device in the form of processed animation data representing the motion of one or more 3D characters. In many embodiments, the server system implements a protocol to preserve synchronization between the data acquisition device up-streaming of motion data and the server system down-streaming of animation data. In several embodiments, the protocol adapts the down-stream frame rate in response to the up-stream frame rate.

Although the present invention has been described in certain specific embodiments, many additional modifications and variations would be apparent to those skilled in the art. It is therefore to be understood that the present invention may be practiced otherwise than specifically described, including various changes in the size, shape and materials, without departing from the scope and spirit of the present invention. Thus, embodiments of the present invention should be considered in all respects as illustrative and not restrictive.

What is claimed:

1. A system configured to perform remote markerless motion capture to drive a 3D character model in real time, comprising:
an optical device connected to a data acquisition device, where the combination of the optical device and the data acquisition device is configured to perform markerless motion capture; and
a server system configured to communicate with the data acquisition device via the Internet;
wherein the server system is configured to receive motion capture data from the data acquisition device; and
wherein the server system is configured to generate motion data to animate a 3D character model based upon the received motion capture data.

2. The system of claim 1, wherein the optical device is a time of flight camera.

3. The system of claim 1, wherein:
the data acquisition device includes a game engine client configured to render 3D animations based upon 3D animation information received from the server system; and
the server system is configured to stream 3D animation information to the data acquisition device including the motion data generated by the server system based upon the received motion capture data.

4. The system of claim 3, wherein the server system is configured to control the frame rate of the generated animation data in response to the frame rate of the received motion capture data and in response to Internet bandwidth constraints.

5. The system of claim 1, wherein:
the server system is configured to match the motion capture data against a set of predetermined command gestures; and
the server system is configured to generate predetermined motion data based upon matching the motion capture data with a command.

6. The system of claim 1, wherein the server system is configured to generate motion data influenced by the received motion capture data.

7. The system of claim 6, wherein the server system is configured to generate motion data by at least retargeting the motion data to a 3D character model.

8. The system of claim 7, wherein the server system is configured to generate motion data by at least generating synthetic motion data influenced by the retargeted motion capture data.

9. The system of claim 6, wherein the server system is configured to generate motion data by at least:
generating synthetic motion data influenced by the received motion capture data; and
combining aspects of the received motion data with aspects of the synthetic motion data.

10. A method of animating a 3D character, comprising:
performing markerless motion capture using an optical device;
providing the markerless motion capture data to a remote server system;
generating motion data using the server system based upon the markerless motion capture data; and
animating a 3D character using the generated motion data.

11. The method of claim 10, wherein the optical device is a time of flight camera.

12. The method of claim 10, wherein the markeless motion capture data is expressed in terms of joint center points and joint rotation parameters.

13. The method of claim 10, further comprising:
matching the markerless motion data using the server system against a predetermined set of commands; and
generating the motion data using a predetermined motion associated with an identified command.

14. The method of claim 10, further comprising generating motion data influenced by the received motion capture data using the server system.

15. The method of claim 10, further comprising retargeting the received motion data to a 3D character model using the server system.

16. The method of claim 15, further comprising generating synthetic motion data influenced by the retargeted received motion data.

17. The method of claim 16, further comprising generating motion data based upon a combination of aspects of the synthetic motion data and aspects of the received motion data.

18. The method of claim 10, further comprising streaming 3D animation information including the generated motion capture data to a rendering engine client located remotely.

19. The method of claim 18, further comprising modifying the frame rate of the animation information streamed by the server system in response to the frame rate of the motion capture data received by the server system and the internet bandwidth constraints.
